(19) United States
(12) Patent Application Publication
(10) Pub. No.: US 2002/0133818 A1
(43) Pub. Date: Sep. 19, 2002

(54) Interactive television

(76) Inventor: Gary Rottger, Somers, NY (US)

Correspondence Address: Norris, McLaughlin & Marcus P.A., 220 East 42nd Street, 30th Floor, New York, NY, 10017, US

(21) Appl. No.: 10/043,721

(22) Filed: Jan. 10, 2002

Related U.S. Application Data
(60) Provisional application No. 60/260,771, filed on Jan. 10, 2001.
(60) Provisional application No. 60/261,549, filed on Jan. 12, 2001.

(51) Int. Cl. G06F 13/00

(52) U.S. Cl. 725/37

(57) ABSTRACT

The present invention relates to providing a television program specially prepared for the application to be interactive with the viewer. The source of the television program may vary, for example, it may be broadcasted material, VCR playback or a DVD playback. The program is enhanced with an inaudible high frequency embedded in the audio portion of the program. The signal, via a high frequency decoder and microprocessor is being transmitted by an infra red transmitter. Upon being received by the viewer with an infra red receiver, the signal is being processed and either displayed on a LCD display or made audible by a sound processor.

### RELATED APPLICATIONS

The present application claims priority from U.S Provisional Application Serial No. 60/260,771 entitled “Interactive Television”, filed on Jan. 10, 2001. The present application also claims priority from U.S. Provisional Application Serial No. 60/261,549, filed Jan. 12, 2001, which is incorporated by reference herein.

### BACKGROUND OF THE INVENTION

1. Field of the Invention

The present invention relates to providing a television program enhanced such as to allow interactive participation by the viewer. The source of the television program may vary, for example, it may be broadcasted material, VCR playback or a DVD playback. The enhancement of the television material provides for a program containing an encoded audio signal, embedded into the existing audio portion of the program. The viewer can decode the encoded audio signal.

2. Description of the Related Art

Interactive television systems for numerous purposes are known in the art. However, in most instances, the viewer's participation in the television program is accomplished via a telephone interface, see, for example U.S. Pat. No. 5,936,661 and U.S. Pat. No. 6,075,527. However, no system is known which provides television programs or recorded VCR or DVD programs which include an encoded audio signal, which, upon proper processing, interacts at the receiver end with the program in a variety of forms, for example, as an audible form or in display mode.

### SUMMARY OF THE INVENTION

The object of the present invention provides for a television program which as been specially prepared by providing an encoded audio signal embedded in the regular audible portion of the program. The audio signal including the embedded encoded signal is sent via an audio decoder and a micro processor to an infra red transmitter, from where the signal is being transmitted to a receiver unit at the viewer's end. Here, it is decoded and processed into text or sounds, or a host of commands that could trigger a variety of functions. A separate and discrete unit to provide text, sounds and other functions may also directly decode the embedded encoded audio signal.

A particular application of the present invention is contemplated for interactive participation by young children in that it involves these children in participating in a program in an entertaining and educational way. The child watches a particular televised show or recorded program, for example, one that provides a particular popular character. The show has been enhanced with the encoded signal, embedded in the audio portion of the program. The signal is received by a decoder and is being transmitted by an infra red transmitter device. The viewing child is equipped with an infra red receiver and a microprocessor which is, for example, embedded in a toy version of the popular character of the show. Thus, upon proper programming, the receiver unit in the toy is able to mimic the television character. That is, when the television character laughs or giggles, so does the decoder toy.

In another embodiment, it is contemplated to provide a receiver with a LCD screen for displaying text. In this embodiment, the character in the television program may be involved in pronouncing and spelling words and the LCD screen would show the spelled word in letters. Thus, the child associates the sound and spelling with the actual written letters of the written word.

Other embodiments are contemplated in which the embedded signals are characteristic of the television show. If the show is a suspense mystery, the embedded signals can have a “clue” or “hint”, important for solving the mystery.

Other embodiments contemplate viewers' participation in game shows by providing answers to the home viewer on an LCD screen, which is not available and not to a live audience in the studio.

Other embodiments may include an audible encoded audio signal which may be decoded directly by the toy or game eliminating the need for the initial decoder and infra red transmitter unit.

Thus, an interactive television system for receiving transmitted signals containing embedded audio control signals is disclosed. The system includes a receiving unit having a decoder, a microprocessor and a signal display. The receiving unit receives the transmitted signals. The embedded audio signals are, for example, supersonic and decoded by a transmitter including a supersonic audio decoder, a micro processor and an infra re transmitter for transmitting the embedded supersonic signals. The transmitted infra red signals are received by an infra red decoder, a second microprocessor and a signal display, and wherein the receiving unit receives the transmitted signals. The ultra high frequency is inaudible. The signal display is a LCD display or a sound processor. The receiver unit may be in the outer shape of a toy, a game or an infra red receiving personal digital assistant (PDA) device.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 is a block diagram of the operation of system;

FIG. 2 is an example of a configuration of the system for providing interactive television according to an embodiment of the invention.

FIG. 3 is a block diagram of another embodiment of the invention.

### DETAILED DESCRIPTION OF THE PRESENTLY PREFERRED EMBODIMENTS

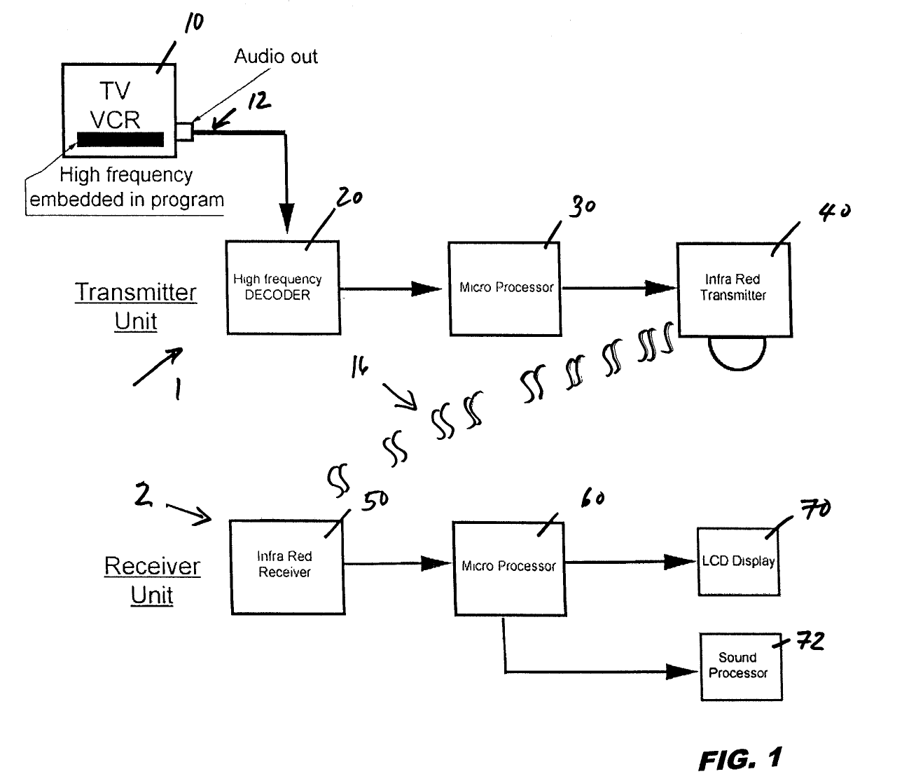

By way of example, the invention is shown and described for viewing a television program which has been specially prepared by providing an inaudible high frequency audio signal which is embedded in the regular audible portion of the program. As shown in FIG. 1, the audio signal is brought in from the TV or VCR unit 10, the audio signal is brought to the transmitter unit 1, which includes a high frequency decoder 20, a micro processor 30 and an infra red transmitter 40. Accordingly, from the TV or VCR 10, the outgoing audio output 12 is received by the high frequency decoder 20 which is connected to the micro processor 30, which in turn is connected to an infra red transmitter 40. Thus, the decoded, processed audio signal is received by the infra red transmitter 40. A receiving unit 2, which includes an infra red receiver 50, a second micro processor 60 and a LCD Display 70, receives the audio signal with the infra red receiver 50. The microprocessor processes the signal and the processed signal can be received either with an LC display 70 or with a sound processor 72 which generates an audible sound. The receiving unit 2 is associated with the viewer and may be in form of a toy, a game, a personal digital assistant (PDA), such as a palm pilot. The choices of types of receiving units depend on the type of signal that is embedded and the type of audience targeted for receiving the program.

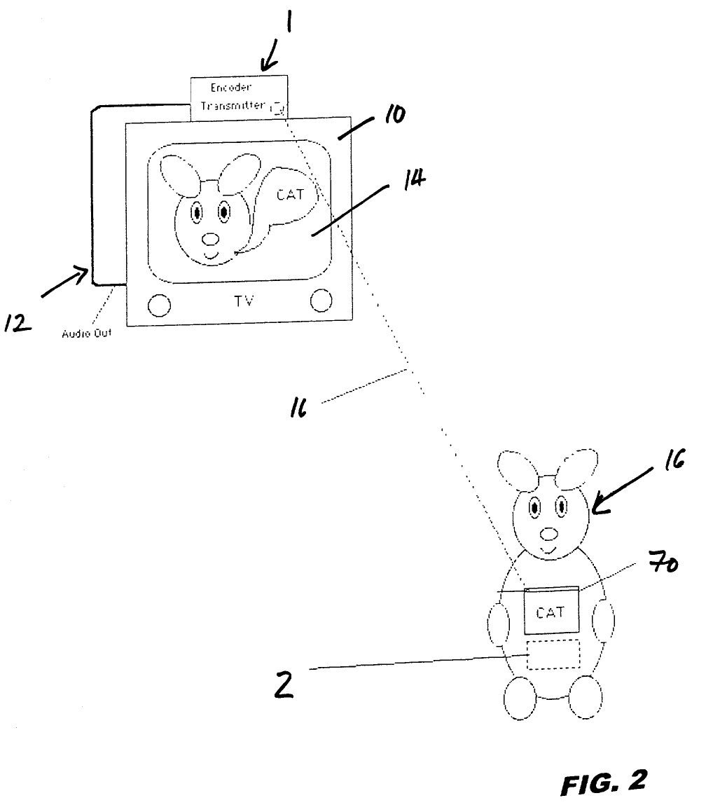

A particular application of the present invention is contemplated for interactive participation by young children, in that it involves these children in participating in a program in an entertaining and educational way. For example, a child watches a particular televised show or recorded program 14, for example, one that also provides a particular popular character 16. The show 14 is enhanced with an inaudible high frequency, embedded in the regular audio portion of the program. The transmitter device unit 1 receives the signal 12. The data stream transmitted includes simple instruction sets, similar to a remote for a television. Depending on the embedded signals and the set up of the receiving unit, the data stream 16 can provide a variety of signals in the receiving unit 2. In the embodiment provided in FIG. 2, a viewing child is equipped with a receiving unit 2, which is, for example, embedded in a toy version of a popular character of the show the child is viewing. Thus, upon proper programming, the receiving toy 2 is able to mimic the television character. That is, when the television character laughs or giggles, the receiver toy produces laughing and giggle sounds, which sounds are generated by the received signal in the sound processor 72 of the receiving unit 2. However, the configuration of the audio signal may also provide for transmitting a signal that is coordinated to the television show such that a character in the TV program may be involved in spelling words. Here, in the example shown in FIG. 2, the character on the television show pronounces and spells “CAT”. The transmitted signal allows the spoken word to be visible as a written word on the LCD screen 70 at the receiving unit 2 in form of the letters “CAT”. Thus, the child associates the spelling with the actual written letters.

Other embodiments are contemplated in which the embedded signals are characteristic of the show, that is, if the show is a suspense mystery, the embedded signals can have a “clue” or “hint” characteristic of the show for making the viewer more actively involved in the show.

Other embodiments contemplate viewers' participation in game shows by providing answers to the home viewer and not to a live audience in the studio.

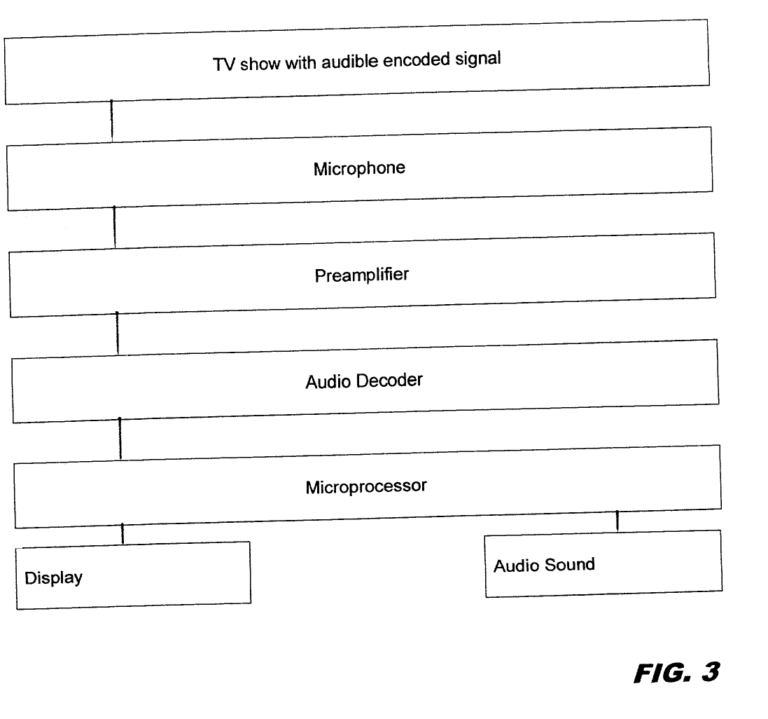

An alternative embodiment is shown in FIG. 3 and differs from the first embodiment by eliminating the decoder and infra red transmitter. Referring to FIG. 3, the TV show/program 10 is encoded with a unique audible signal in the studio track, which is decoded by the target system 3. The target system 3 includes a microphone 52 and a suitable preamplifier 54, an audio to digital decoder 56, a microprocessor 65, a display 70, and a sound generating device 72. The signal, which is encoded in the television program 10, is a unique tone pair or serial data encoded via frequency shift keying or another appropriate modulation. The audio of the television show is reproduced by the viewer's television, thus, broadcasting the encoded audible signal to the target system 3. The microphone 52 in the target system receives the signal, it is amplified by the microphone preamplifier 54 and applied to the decoder circuit 56. The decoder circuit 56 provides both notification of valid data as well as data to the microprocessor 65 where the preprogrammed appropriate action is assigned. The assignment by the microprocessor 65 may include writing text on a LCD display 70, as well as creating audible signals 72 so as to provide stimulation to the viewer.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. An interactive television system for receiving transmitted embedded audio control signals comprising:
a receiving unit including a decoder, a micro processor and a signal display, and wherein the receiving unit receives the transmitted signals.

2. The interactive television system according to claim 1, wherein the audio control signals are supersonic and decoded by a transmitter including a supersonic audio decoder, a micro processor and an infra red transmitter for transmitting the embedded supersonic signals.

3. The interactive television system according to claim 2, wherein the transmitted infra red signal is received by an infra red decoder, a second microprocessor and a signal display, and wherein the receiving unit receives the transmitted signals.

4. The interactive television system according to claim 1, wherein the audio control signal is ultra high frequency and inaudible.

5. The interactive television system according to claim 1, wherein the signal display is a LCD display.

4. The interactive television system according to claim 1, wherein the signal display is a sound processor.

5. The interactive television system according to claim 1, wherein the receiver unit is formed as a toy.

6. The interactive television system according to claim 1, wherein the receiver unit is a game.

7. The interactive television system according to claim 1, wherein the receiver unit is an infrared receiving personal digital assistant.

8. The interactive television system according to claim 3, wherein the signal display is a sound processor.

9. The interactive television system according to claim 1, wherein the receiver unit is formed as a toy.

10. The interactive television system according to claim 3, wherein the receiver unit is a game.

11. The interactive television system according to claim 3, wherein the receiver unit is an infrared receiving personal digital assistant.
